(19) United States
(12) Patent Application Publication
(10) Pub. No.: US 2005/0062240 A1
(43) Pub. Date: Mar. 24, 2005

(54) Snowboard control device

(76) Inventor: Kerchival Holt, Cupertino, CA (US)

Correspondence Address: BAY AREA INTELLECTUAL PROPERTY GROUP, LLC, PO BOX 210459, SAN FRANCISCO, CA, 94121-0459, US

(21) Appl. No.: 10/941,700

(22) Filed: Sep. 14, 2004

Related U.S. Application Data
(60) Provisional application No. 60/504,555, filed on Sep. 19, 2003.

(51) Int. Cl. B62B 9/04

(52) U.S. Cl. 280/28.11

(57) ABSTRACT

A snowboard control device for controlled braking is provided which may be adapted into the front or rear of a conventional snowboard. The snowboard control device comprises means for frictionally contacting a riding surface that the snowboard is riding upon, such as ice or snow, for example. The frictional contact means is movably joined to the snowboard such that the frictional contact means may be selective engage the riding surface. Means are also provided for selectively engaging the frictional contact means into the riding surface to effect the controlled braking of the snowboard. Means to restore the frictional contact means to a disengaged position is also provided. In this way, the snowboard rider is provided effective speed control during a straight-line descent.

### CROSS-REFERENCE TO RELATED APPLICATIONS

The present Utility patent application claims priority to U.S. provisional application for patent No. 60/504,555 filed on Sep. 19, 2003.

### FIELD OF THE INVENTION

The present invention relates generally to braking devices for snowboards. More particularly, the invention relates to braking devices that enhance the maneuverability and downward velocity of the rider during normal use.

### BACKGROUND OF THE INVENTION

Snowboards have been created with brake devices. These devices are generally intended to control descent of the ski or snowboard (a snowboard is generally like a wide ski) after the rider has been disengaged from the ski or snowboard. That is, conventional ski/snowboard brakes are generally not suitable for controlled braking while the user is riding the snowboard during normal use. Known braking techniques engage when the user disengages the binding or boot, operate in a binary “on or off” mode, and are located on the ski or snowboard in such a way that tends to interfere with the normal edge control necessary for normal use of such devices.

In view of the foregoing, there is a need for improved techniques for snowboard braking. It would be desirable for these improved techniques to have proportionate, controlled braking that enhances maneuverability and downward velocity while riding the snowboard.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a profile view of a snowboard fitted with a braking control device in accordance with a first embodiment of the present invention;

FIG. 2 illustrates a profile view of the device in FIG. 1 in the fully engaged position in accordance with the first embodiment of the present invention;

FIG. 3 illustrates a top view of the first embodiment in FIG. 1;

FIG. 4 illustrates a top sectional view showing a snow and ice protective cover in accordance with an embodiment of the present invention;

FIG. 5 illustrates a top view of a braking control device in accordance with a second embodiment of the present invention; and

FIGS. 6a and b illustrate a top and side view, respectively, of a braking control device in accordance with a third embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of methods of implementing a control braking device for snowboards, and the like are provided.

In particular, a ski control device for controlled braking is provided where in one embodiment is mounted onto the rear of a conventional snowboard by altering the snowboard, and in another embodiment requires altering of the snowboard. The snowboard control device comprises means for frictionally contacting a riding surface that the snowboard is riding upon, such as ice or snow, for example. The frictional contact means is movably joined to the snowboard such that the frictional contact means may be selective engage the riding surface. In some embodiments, the frictional contact means is a strait braking dam. In other embodiments, the frictional contact means is a curved braking dam. Means are also provided for selectively engaging the frictional contact means into the riding surface to effect the controlled braking of the snowboard. A preferred embodiment of the present invention comprises means to restore the frictional contact means to a disengaged position so that no breaking of the snowboard occurs due to the present invention. In this way, the snowboard rider is provided effective speed control during a straight-line descent.

Some embodiments of the present invention further include means for protecting moving joints of the movable joining means from jamming by contamination, such as, for example, snow, dirt, and ice.

In yet other embodiments, the front and rear of the snowboard adapted to operate with the present snowboard control device.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. Therefore, specific details disclosed herein are not to be interpreted as limiting, but rather as a basis for the claims and as a representative basis for teaching one skilled in the art to employ the present invention in virtually any appropriately detailed system, structure or manner.

Although the present invention is described in the following embodiments are directed, by way of example, towards snowboard implementations, those skilled in the art will readily recognize that the principles and techniques taught may be readily adapted to a multiplicity of other suitable application, including but not limited to skis, for example. For the sake of clarity and simplicity, the following description will be primarily focused on snowboards, but it should be understood that all suitable applications are likewise contemplated as within the scope of the present invention. In the context of the present description, ski and snowboard are used synonymously, given that a snowboard is essentially just a wide ski.

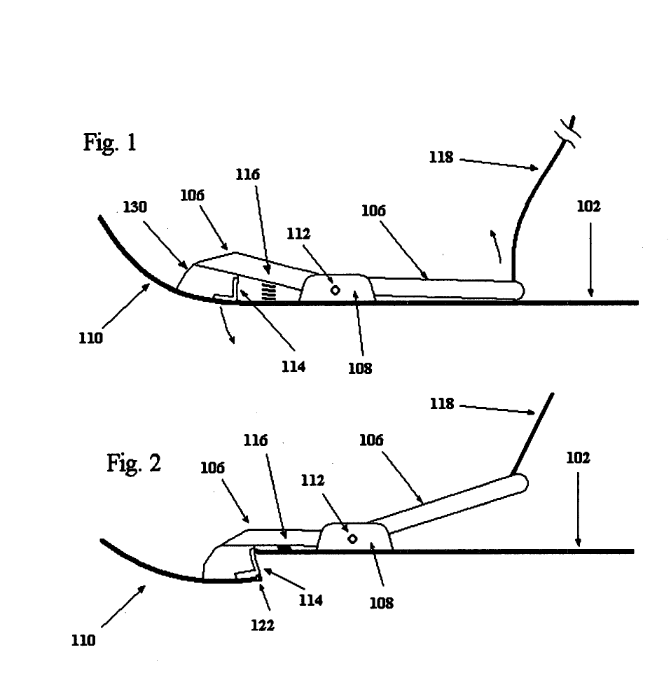

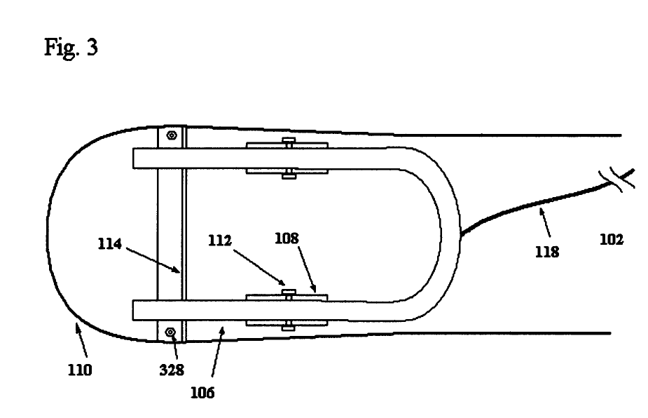

FIG. 1 illustrates, by way of example, and not limitation, a profile view of a snowboard fitted with a braking control device in accordance with a first embodiment of the present invention. FIG. 2 illustrates a profile view of the device shown in FIG. 1 in the fully engaged position in accordance with the first embodiment of the present invention. FIG. 3 illustrates a top view of the first embodiment shown in FIG. 1. A bolt 328 may be used to secure snow dam 114 fixedly onto the front of board 110; however, any suitable means may be used depending on the application.

The first embodiment is a snowboard control device that acts as a dynamic brake to alter a snowboard rider's downhill speed. The device is actuated by means of a control line held by the rider and deactivated automatically preferably by a return spring, or some other suitable position restoring means. Other suitable position restoring means includes, but is not limited to, twist springs that fit around hinge pin 112.

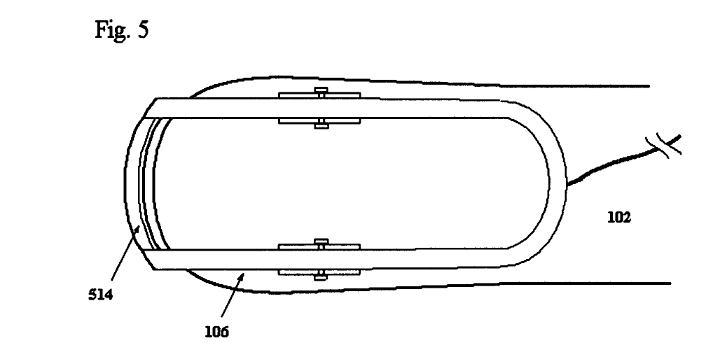

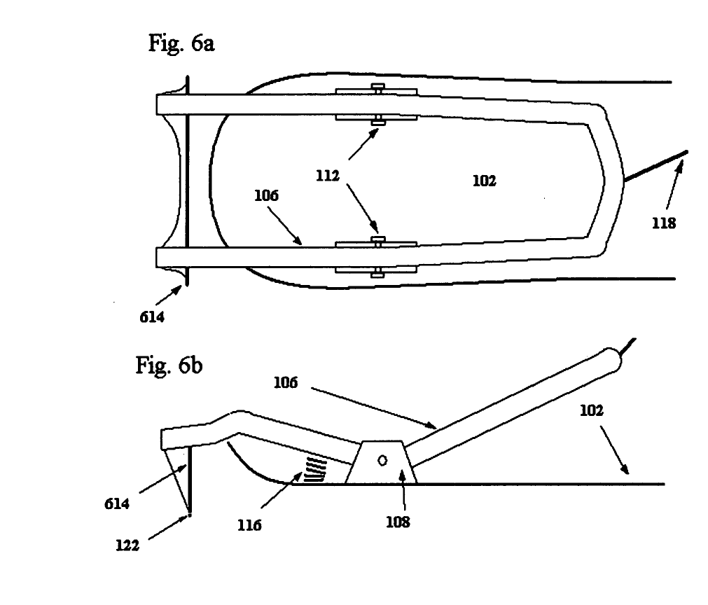

One retrofitting approach to adapting a conventional snowboard according to the first embodiment is comprised of removing (e.g., cutting off) the snowboard's curved tail section 110 and reattaching it to control arms 106 and a brake dam 114. In alternative embodiments where the snowboard has a strait instead of a curved tail section, the snowboard might not require cutting, and, instead of a curved braking section, a suitable flat braking section could be similarly added as described for curved tail section 110. Snow dam 114 is preferably made from suitable “L” channel material (e.g., steel), where the vertical portion acts as the brake dam and the horizontal portion is fixedly attached to tail section 110. The ends of control arms 106 are preferably pre-attached to the control dam as shown in FIG. 5. By way of example, and not limitation, control arms 106 may also be fixedly connected to snow dam 114 using braces or other known techniques. However, other suitable approaches may be implemented depending on the application. The leading edge of tail section 110 or the bottom of the “L” channel, brake dam, is preferably affixed with a relatively small, protective edge 122 (see FIG. 2) made of steal or other suitable material, which is preferably configured to provide enough clearance so that tail section 110 may form a level bottom surface with a snowboard 102.

Control arms 106 are pivotally attached at a hinge pin 112 to control arm hinges 108, which hinges are fixedly attached by known means (e.g., mounting screws, glue, etc.) to the top of snowboard 102, thereby forming a braking assembly which may be actuated by lifting the free end of control arm 106 to push down tail section 110 and proportionately expose brake dam 114, which increasingly digs into the snow as tail section 110 is pushed further down, thereby achieving a desired amount of braking friction. The rider proportionally engages the present braking device to create a deeper or shallower dam thus causing a corresponding greater or lesser amount of braking force. Hence, the amount of force applied by the user to lift the free end of control arm 106 controls how far control arm 106 travels, and therefore the amount of braking force. As the lifting force is removed by the user, return compression springs 116 restore the tail section braking assembly towards the disengaged position.

In some alternative embodiments, a similar braking assembly as that described for the tail section may instead, or additionally, be similarly configured on the front of the snowboard. The braking assembly of FIG. 1 is configured onto the front and rear portions of a snowboard, it is possible for snowboard riders to descend a slope with either end of the snowboard pointing in the downward direction of the slope.

The free end of control arm 106 may be lifted to engage the present brake assembly in a multiplicity of suitable ways that those in the art will readily know how to implement as required by the particular application. By way of example, an not limitation, for hand or upper body operation, a control tether 118 may attached to the free end of control arm 106 and pulled by hand to proportionately engage the brakes. In other applications, for example, a suitable foot activation scheme may be implemented. In yet other embodiment, the proportional aspect of the present invention may not be required, and a suitable binary engagement/disengagement system may be instead implemented while still taking advantage of the other desirable aspects of the present invention. Some embodiments may replace a tether approach with a bicycle-style brake cable and handheld lever, which are used to actuate the brake dam, whereby the brake cable actuates the control arm. Electromechanical embodiments of the brake actuation system exist, where actuation of the control arm is by way of a small electronic motor or a small hydraulic pump, whereby, for example, the rider could engage the present brake through a small switch on a handgrip.

In a typical application, the rider attaches the control tether 118 to his or her person after strapping on the snowboard. While descending a slope during use the rider attains a certain velocity and normally slows his or her velocity by performing turns. In situations where turns are difficult (e.g., narrow trails or crowded slopes) a rider needs to lose velocity with less turning or no turns at all. In this situation, for example, the rider could engage the present braking device by pulling in an upward motion on control tether 118 (the rear tether if two braking devices are mounted on the snowboard). This engages the present braking device and causing an opposing frictional force that slows down the snowboard and rider, thereby making a turn less likely to be required. Those skilled in the art will appreciate that one aspect of the first embodiment is that there is no significant inhibition of the lateral force needed to control the turning of a snowboard.

Snow dam 114 may be constructed of any suitable material including but not limited to metal, plastic, or similar material. Protective edge 122 is constructed and configured to prevent wear and tear at the mounting joint of brake dam 114. Snow dam 114 is preferably curved in the first embodiment such that there is only a small gap between the brake dam and snowboard 102. In many applications, a gap would allow snow to build up and thus cause difficulty in retracting the braking dam. Some snow conditions permit a dam that would not collect snow while braking.

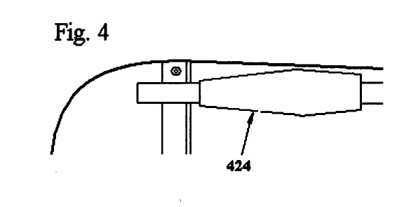

FIG. 4 illustrates a top sectional view showing a snow and ice protective cover 424 in accordance with an embodiment of the present invention. In some applications, protective cover 424 may be fitted to protect the pivoting joint parts from jamming or tangling with other ski equipment.

The first embodiment is primarily directed towards retrofitting applications of the present invention that alter the snowboard, however a second and third embodiments of the present invention will be described that do not require any significant alteration of the snowboard.

FIG. 5 illustrates a top view of a braking control device in accordance with a second embodiment of the present invention. As shown in the Figure, the second embodiment is substantially the same as the first embodiment except that there is no curved tail section and a brake dam 514 is fixedly attached or formed as part of the control arm. Moreover, like the first embodiment, a minimal gap between the brake dam and snowboard 102 prevents jamming problems due to ice, snow. Snow dam 514 also has a curved shape instead of a strait line as in the first embodiment. One application of the second embodiment is in situations where snow conditions demand a brake dam that will not jam or if a straighter line of descent is desired while the device is engaged.

FIGS. 6a and b illustrate a top and side view, respectively, of a braking control device in accordance with a third embodiment of the present invention. The third embodiment is similar to the second embodiment except that control arms 106 are shaped to accommodate a snowboard with a curved tail and a brake dam 614 is shaped in a strait line as in the first embodiment. In the first and third embodiments, the brake dam is effectively perpendicular to the motion of the descending snowboard. In one aspect, a straight brake dam does not greatly impede a sideways movement by the rider to initiate a turn.

In alternative embodiments of the brake dam, the brake dam is actuated through a slot in the rear (or front) of the board. This slot would extend to approximately ¾ of an inch to the sides of the board. The remaining ¾ of an inch of the board on each side would be reinforced. In other alternative embodiments of the brake dam, the brake dam could be locked in the disengaged position if the rider desired to disable the braking device of the present invention. In yet other alternative embodiments of the brake dam, the opposite may be implemented, where the brake dam could be locked in the engaged position to prevent further use of the snowboard; thereby, for example, preventing theft or accidental use.

In one aspect, the user is provided effective speed control during a straight-line descent. Those skilled in the art will appreciate the relatively simple design of present invention, and that it is designed to be highly resistant jamming in snow and ice. Embodiments of the present invention may be retrofitted to conventional snowboards or originally manufactured according to the above teachings.

Having fully described at least one embodiment of the present invention, other equivalent or alternative methods of implementing a control braking device for skis, snowboards, and the like according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. A snowboard control device for controlled braking, the device comprising:
a snowboard adapted to operate with the snowboard control device;
means for frictionally contacting a riding surface that the snowboard is riding upon;
means for movably joining said frictional contact means to the snowboard such that said frictional contact means may be selective engage the riding surface; and
means for selectively engaging said frictional contact means into the riding surface.

2. The snowboard control device of claim 1 further comprising means to restore said frictional contact means to a disengaged position.

3. The snowboard control device of claim 1 further comprising means for protecting moving joints of said movable joining means from jamming by contamination.

4. The snowboard control device of claim 1 wherein the front and rear of the snowboard adapted to operate with the snowboard control device.

5. The snowboard control device of claim 1 wherein said selective frictional engaging means comprises means for locking said frictional contact means into a disengaged position.

6. The snowboard control device of claim 1 wherein said selective frictional engaging means comprises means for locking said frictional contact means into a engaged position.

7. A snowboard control device for controlled braking, the device comprising:
means for frictionally contacting a riding surface that a snowboard is riding upon;
means for movably joining said frictional contact means to the snowboard such that said frictional contact means may be selective engage the riding surface; and
means for selectively engaging said frictional contact means into the riding surface.

8. The control device of claim 7 further comprising means to restore said frictional contact means to a disengaged position.

9. The snowboard control device of claim 7 wherein the snowboard control device is operably adapted onto the front and rear of the snowboard.

10. The snowboard control device of claim 7 wherein said selective frictional engaging means comprises means for locking said frictional contact means into a disengaged position.

11. The snowboard control device of claim 7 wherein said selective frictional engaging means comprises means for locking said frictional contact means into a engaged position.

12. The snowboard control device of claim 7 further comprising means for protecting moving joints of said movable joining means from jamming by contamination.

13. A snowboard control device for controlled braking, the device comprising:
means for frictionally contacting a riding surface that a snowboard is riding upon;
means for movably joining said frictional contact means to the snowboard such that said frictional contact means may be selective engage the riding surface;
means for selectively engaging said frictional contact means into the riding surface; and
means to restore said frictional contact means to a disengaged position.

14. The snowboard control device of claim 13 wherein the snowboard control device is operably adapted onto the front and rear of the snowboard.

15. The snowboard control device of claim 13 wherein said selective frictional engaging means comprises means for locking said frictional contact means into a disengaged position.

16. The snowboard control device of claim 13 wherein said selective frictional engaging means comprises means for locking said frictional contact means into a engaged position.

17. The snowboard control device of claim 13 further comprising means for protecting moving joints of said movable joining means from jamming by contamination.
